(19) United States
(12) Patent Application Publication
(10) Pub. No.: US 2021/0295358 A1
(43) Pub. Date: Sep. 23, 2021

(54) Synchronizing Survey Collection with Ad Distribution During an Ad Campaign

(71) Applicant: Truex Inc., Los Angeles, CA (US)

(72) Inventors: Binbin Li, Redondo Beach, CA (US); Maxim Budninskiy, Porter Ranch, CA (US); Joshua Rangsikitpho, Malibu, CA (US); Jamie Auslander, Los Angeles, CA (US); Kenneth Hwang, Los Angeles, CA (US); Amanda Conrad, Van Nuys, CA (US); Simon Asselin, Sammamish, WA (US)

(73) Assignee: DISNEY ENTERPRISES, INC.

(21) Appl. No.: 16/821,815

(22) Filed: Mar. 17, 2020

(51) Int. Cl. G06Q 30/02

(52) U.S. Cl. CPC G06Q 30/0203; G06Q 30/0254; G06Q 30/0245

(57) ABSTRACT

A system includes a hardware processor and a memory storing software code for controlling distribution of ad surveys to target audiences. For each target audience, the hardware processor executes the software code to receive ad data describing an ad volume distributed to the target audience during a predetermined time interval of an ad campaign, and to receive survey data describing a survey volume distributed to the target audience and a survey response volume collected from the target audience during the predetermined time interval. The software code also determines a next survey sampling rate for the target audience based on the ad data and the survey data, such that the volume of survey responses collected from the target audience during matches an ad distribution volume for the target audience within a predetermined threshold during each predetermined time interval of the ad campaign.

### BACKGROUND

Advertising (ad) campaign strategies are increasingly reliant on the collection of vast amounts of data regarding potential customers to determine when and where to target advertisements in order to best ensure a successful ad campaign. Moreover, in online advertising, it is important to be able to correctly and accurately evaluate the performance of an ad campaign in real-time. The performance of an ad campaign demonstrates whether or not an advertising strategy results in a positive return on investment (ROI) and guides further actions, such as budget allocation and campaign operations, for example.

One technique for assessing ad campaign performance during the campaign is to evaluate surveys completed by human responders who are exposed to the advertising, as well as from human responders who are not. Surveys are typically collected from exposed-group responders (responders that have been exposed to an ad campaign that is being assessed) and control-group responders (responders that have not been exposed to the ad campaign), in real-time. Because the effectiveness of the ad campaign may be determined by the difference between the survey responses collected form the exposed-group and control-group responders, the accuracy of that effectiveness determination depends on how well the sampled population of responders represents the overall target consumer population for the ad campaign.

### SUMMARY

There are provided systems and methods for synchronizing survey collection with ad distribution during an ad campaign, substantially as shown in and/or described in connection with at least one of the figures, and as set forth more completely in the claims.

### BRIEF DESCRIPTION OF THE DRAWINGS

FIG. 1 shows a diagram of an exemplary system for synchronizing survey collection with ad distribution during an ad campaign, according to one implementation;

FIG. 2 shows a diagram of an exemplary software code for synchronizing survey collection with ad distribution during an ad campaign, according to one implementation;

FIG. 3A shows a flowchart presenting an exemplary method for use by a system for synchronizing survey collection with ad distribution during an ad campaign, according to one implementation;

FIG. 3B shows a flowchart presenting an extension of the exemplary method outlined in FIG. 3A, according to one implementation; and

FIG. 4 shows an exemplary simulation comparing survey collection with ad distribution over the course of an ad campaign.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for synchronizing survey collection with ad distribution during an ad campaign which overcome the drawbacks and deficiencies in the conventional art. It is noted that, as used in the present application, the term “ad” refers to an advertisement or advertisements, or to advertising, as is readily interpretable from the context in which the term “ad” is used. By way of example, the expressions “ad data” and “ad volume” refer respectively to advertisement data and advertisement volume, while the expression “ad campaign” refers to an advertising campaign.

It is further noted that, as used in the present application, the terms “automation,” “automated”, and “automating” refer to systems and processes that do not require human intervention. Although, in some implementations, a human system administrator may review or even modify survey distribution decisions made by the systems and according to the methods described herein, that human involvement is optional. Thus, the survey distribution determinations described in the present application may be performed under the control of hardware processing components executing them.

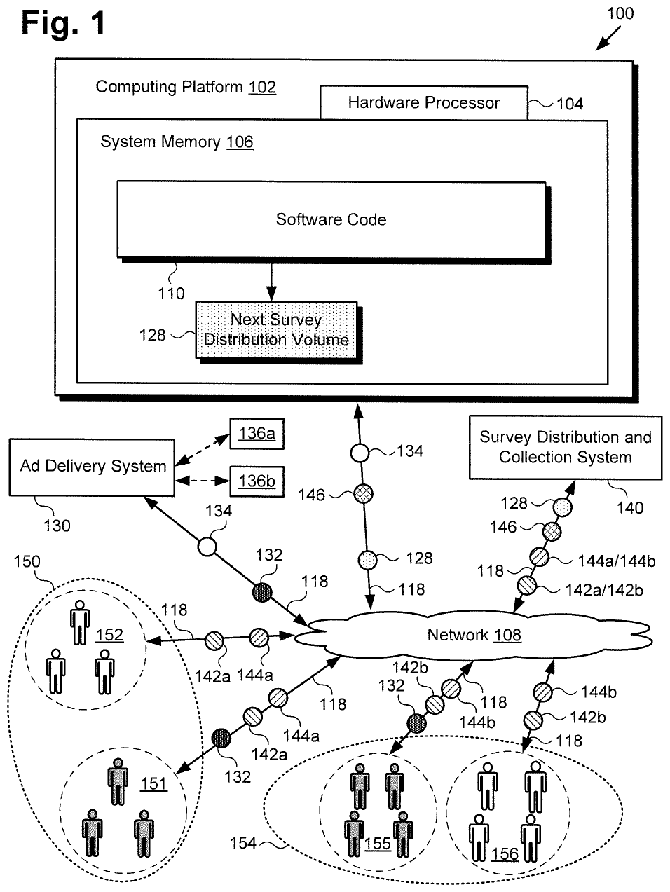

FIG. 1 shows a diagram of an exemplary system for synchronizing survey collection with ad distribution during an ad campaign, according to one implementation. As discussed below, system 100 may be implemented using a computer server accessible over a local area network (LAN) or may be implemented as a cloud-based system. As shown in FIG. 1, system 100 includes computing platform 102 having hardware processor 104, and system memory 106 implemented as a non-transitory storage device. According to the exemplary implementation shown in FIG. 1, system memory 106 stores software code 110 used to control distribution of ad surveys to target audiences 150 and 154 during an ad campaign.

As further shown in FIG. 1, system 100 may be implemented in a user environment including ad delivery system 130 and survey distribution and collection system 140 communicatively coupled to system 100 via communication network 108 and network communication links 118. In addition, FIG. 1 shows ads 132 distributed to exposed-group 151 of target audience 150, ads 132 distributed to exposed group 155 of target audience 154, surveys 142a distributed to exposed-group 151 and control-group 152 of target audience 150, surveys 142b distributed to exposed-group 155 and control-group 156 of target audience 154, survey responses 144a collected from exposed-group 151 and control-group 152 of target audience 150, and survey responses 144b collected from exposed-group 155 and control-group 156 of target audience 154. Also shown in FIG. 1 are content distribution platforms 136a and 136b used by ad delivery system 130 to distribute ads 132, ad data 134, survey data 146, and next survey sampling rate 128 determined by system 100 using software code 110.

By way of overview, when a survey is run, the same survey questionnaire is typically served to the exposed-group and control-group within a target audience. These two sets of surveys are collected simultaneously but from different people (i.e., audience members in the exposed-group and control-group are mutually exclusive). The total number of surveys to be collected from each group during an ad campaign, (hereinafter “the survey quota”) are usually equal, but don't have to be. Business rules typically determine how many control-group and exposed-group surveys are desirable. The numbers of collected control-group surveys and exposed-group surveys are counted separately, each under the guide of its own survey control rates.

With respect to the representation of system 100 shown in FIG. 1, it is noted that although software code 110 is depicted as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to a hardware processor of a computing platform, such as hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

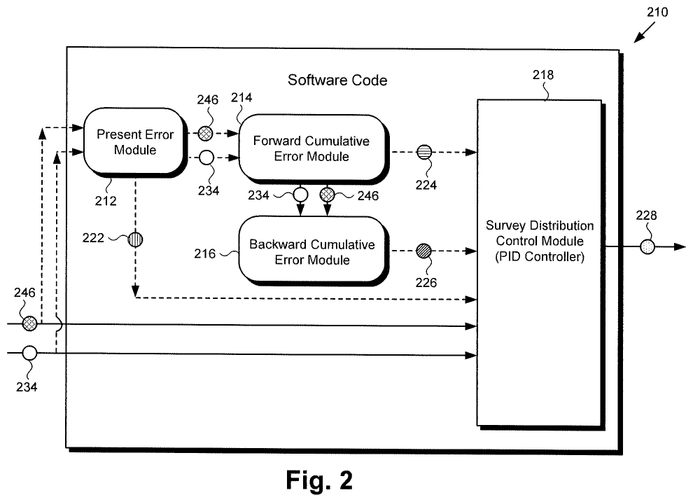

It is further noted that although FIG. 1 depicts software code 110 as being stored in its entirety on a single computing platform, that representation is also merely provided as an aid to conceptual clarity. More generally, system 100 may include one or more computing platforms, such as computer servers for example, which may be co-located, or may form an interactively linked but distributed system, such as a cloud-based system, for instance. As a result, hardware processor 104 and system memory 106 may correspond to distributed processor and memory resources within system 100. Consequently, it is to be understood that the various features of software code 110 shown in FIG. 2 and described below may be stored remotely from one another within the distributed memory resources of system 100.

Computing platform 102 may correspond to one or more web servers, accessible over a packet-switched network such as the Internet, for example. Alternatively, computing platform 102 may correspond to one or more computer servers supporting a wide area network (WAN), a LAN, or included in another type of private or limited distribution network.

By way of background, a live ad campaign typically runs on multiple content distribution platforms 136a and 136b, e.g., digital streaming services such as those provided by Hulu® or Twitch®, for example that display ads during the ad campaign. Each content distribution platform delivers some volume of ad units on any day during the ad campaign. Marketing researchers have found that audience members sharing the same demographic parameters, such as gender and/or age, for example, and who receive ads from the same content distribution platform can be shown statistically to respond very similarly to an ad campaign. According to the present inventive principles, a target audience for an ad campaign includes a cohort of individuals who receive content from the same content distribution platform and share at least one other audience parameter in common, such as a demographic parameter, for example.

Thus all members of target audience 150 are users of the same content distribution platform, e.g., content distribution platform 136a or 136b, and share at least one other audience parameter. Similarly, all members of target audience 154 are users of the same content distribution platform, e.g., content distribution platform 136a or 136b, and share at least one other audience parameter. Examples of audience parameters may include demographic parameters such as age, and/or gender, and/or household income, as well as data management platform (DMP) segments providing Internet tracking data indicative of audience member interests, and/or content data such as a show name or episode number of content being consumed by an audience member, to name a few. It is noted that target audiences 150 and 154 must differ from one another with respect to at least one characteristic. For example, target audiences 150 and 154 may be identified with the same content distribution platform but would then differ in at least one other audience parameter. Conversely, target audiences 150 and 154 may share all other relevant audience parameters in common but receives its content from a different one of content distribution platforms 136a or 136b.

It is further noted that the audience parameter and content distribution platform distinctions between target audiences 150 and 154 described above are by reference to a single ad campaign. More generally, multiple ad campaigns may run concurrently and may be directed substantially to the same target audiences having the same demographic characteristics and utilizing the same content distribution platform. That is to say, multiple ad campaigns can use target audience 150 (defined by a demographic parameter and a content distribution platform) and target audience 154 (defined by a demographic parameter and a content distribution that may overlap with but have differences from what defines target audience 150) without changing the members of each target audience. For example, concurrent ad campaigns for competing cola flavored soft drinks may both be directed to target audience 150, as well as to target audience 154. It is also noted that although FIG. 1 shows two target audiences in the interests of conceptual clarity, more generally, the ad campaign may be directed to many more than two target audiences, such as tens, hundreds, or thousands of target audiences, for example.

Although, as noted above, each of target audiences 150 and 154 includes a cohort of individuals who receive content from the same content distribution platform and share at least one other audience parameter in common, those features shared in common by the members of each of target audiences 150 and 154 may be more extensive than merely a common content distribution platform and one or more demographic parameters. That is to say, one of the advantages of the present solution for synchronizing survey collection with ad distribution is that it can be easily extended to target audiences based on their sharing any of several or hundreds of parameters in common. Thus, in addition to, or as alternatives to content distribution platform utilization and demographics, each of target audiences 150 and 154 may be identified based on audience parameters such as their common regional location, the type of device used to view or otherwise consume content (e.g., smartphone, tablet computer, television), or the type of content (e.g., movies, television shows or other episodic content, video game gameplay, e-sports tournaments, etc.), to name a few examples.

Not all members of a particular target audience receive the ads being evaluated during the ad campaign. For example, only exposed-group 151 of target audience 150 receives ads 132, and only exposed-group 155 of target audience 154 receives ads 132. Control-group 152 of target audience 150 does not receive ads 132, and control-group 156 of target audience 154 does not receive ads 132. Moreover, not all members of a particular target audience are surveyed during a particular time interval of the ad campaign. According to the present concepts, for each of target audiences 150 and 154, two ratios are particularly relevant to the accuracy with which the success of an ad campaign can be evaluated: 1) the ratio of the number of members of the target audience who are surveyed to the number of members of all target audiences included in the ad campaign who are surveyed, i.e., the “survey group”; and 2) the ratio of the number of all members of the target audience to the number of all members of all target audiences included in the ad campaign. If those two ratio numbers match, or are very close to each other for every target audience included in the ad campaign, then members of every target audience are equally represented in the survey group as well as the overall audience population as a whole. When that is the case, the collected survey data can be interpreted as accurately reflecting the collective target audience response to the ad campaign.

As a specific example, suppose an ad campaign delivers one hundred thousand (100k) ad units on two content distribution platforms 136a and 136b. Among them, 30k, 30k, 15k, 25k ad units are delivered, respectively, to female viewers of content distribution platform 136a (F-136a), male viewers of content distribution platform 136a (M-136a), female viewers of content distribution platform 136b (F-136b), and male viewers of content distribution platform 136b (M-136b). In such a case, the different target audiences identified by content distribution platforms F-136a, M-136a, F-136b, and M-136b account for 30%, 30%, 15%, and 25% of the overall audience, respectively. If 1,000 surveys are collected, it would be desirable for 300, 300, 150, 250 survey responses to be collected, respectively, from target audiences identified by content distribution platforms F-136a, M-136a, F-136b, and M-136b. When that happens, surveyed users are considered to be aligned with the overall audience, and the collected surveys may form the basis for accurate ad campaign evaluations.

An additional complication is caused by fluctuations in traffic on content distribution platforms 136a and 136b, such as daily fluctuations, or fluctuations over any other predetermined time interval of the ad campaign. In order for the survey process to form the basis of accurate ad campaign evaluations, the collection of surveys has to follow the pace of ad distribution, for each and every day or other predetermined time interval during the ad campaign. Again, as a specific non-limiting example, and based on the exemplary ad and survey numbers described above, if 10k of the 30k content distribution platform F-136a ad units were delivered on one particular day, it would be desirable to collect 10k/30k=⅓ of total surveys on the same day, i.e., collect 100 surveys that day from the target audience identified by content distribution platform F-136a.

Thus, given the survey quota and the total number of ad units to be distributed during the ad campaign (hereinafter “the ad budget”), the challenge is to develop a survey distribution control solution that adjusts survey distribution volume every day, or during each of any predetermined time interval of the ad campaign, for each combination of content distribution platform and audience member demographics, so that surveys are collected at substantially the same pace as ad units are distributed during each predetermined time interval of the ad campaign.

From a computational standpoint, let S(p, d, t) denote the number of surveys collected on content distribution platform p for user demographic d during predetermined time interval t, and let S_{Q} denote the survey quota. In addition, let A(p, d, t) denote the number of ad units (i.e., the ad volume) distributed on content distribution platform p for user demographic d during predetermined time interval t, and let A_{T} denote the total ad budget. The survey distribution control solution disclosed by the present application adjusts the distributed survey sampling rate SSR(p, d, t) on content distribution platform p for user demographic d during predetermined time interval t, such that:

S(p,d,t)/S_{Q}=A(p,d,t)/A_{T}

for every combination of p, d, and t during the ad campaign.

It is noted that the above calculation is performed separately for the exposed-group members and the control-group members of each target audience. Thus, where S_{Control}(p, d, t) denotes the number of surveys collected on content distribution platform p for control-group members sharing user demographic d during predetermined time interval t, S_{Q-Control} denotes the control-groups survey quota, S_{Exposed} (p, d, t) denotes the number of surveys collected on content distribution platform p for exposed-group members sharing user demographic d during predetermined time interval t, and S_{Q-Exposed} denotes the exposed-groups survey quota it is desirable that:

S_{Control}(p,d,t)/S_{Q-Control}=S_{Exposed}(p,d,t)/S_{Q-Exposed}=A(p,d,t)/A_{T}

where once again A(p, d, t) denote the number of ad units distributed on content distribution platform p for user demographic d during predetermined time interval t, and let A_{T} denote the total ad budget.

FIG. 2 shows exemplary software code 210 for synchronizing survey collection with ad distribution during an ad campaign, according to one implementation. As shown in FIG. 2, software code 210 includes at least survey distribution control module 218, which may be implemented as a proportional-integral-derivative (PID) controller, for example. It is noted that a PID controller is typically a closed-loop controller that determines control actions based on one or more negative feedback signals. A PID controller identifies an error value e as the difference between a measured variable y and a desired set point r for that variable, i.e., e=r−y, and applies a correction based on proportional, integral, and derivative terms “P,” “I,” and “D,” respectively of the error value e.

In addition to survey distribution control module 218, in various implementations software code 210 may include one or more of present error module 212 generating present error value 222, forward cumulative error module 214 generating forward cumulative error value 224, and backward cumulative error module 216 generating backward cumulative error value 226. Also shown in FIG. 2 are ad data 234, survey data 246, and next survey sampling rate 228 determined using software code 210.

Ad data 234, survey data 246, and next survey sampling rate 228 correspond respectively in general to ad data 134, survey data 146, and next survey sampling rate 128, in FIG. 1. Thus, ad data 134, survey data 146, and next survey sampling rate 128 may share any of the characteristics attributed to respective ad data 234, survey data 246, and next survey sampling rate 228 by the present disclosure, and vice versa.

Software code 210 corresponds in general to software code 110, in FIG. 1, and those corresponding features may share any of the characteristics attributed to either feature by the present disclosure. Thus, like software code 210, software code 110 may include survey distribution control module 218, implemented as a PID controller for example, as well as features corresponding to one or more of optional present error module 212, optional forward cumulative error module 214, and optional backward cumulative error module 216.

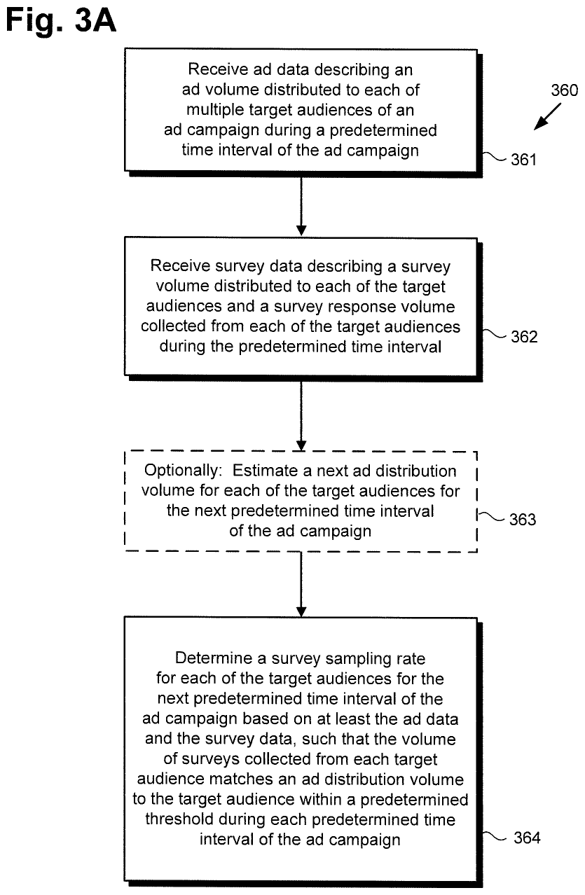

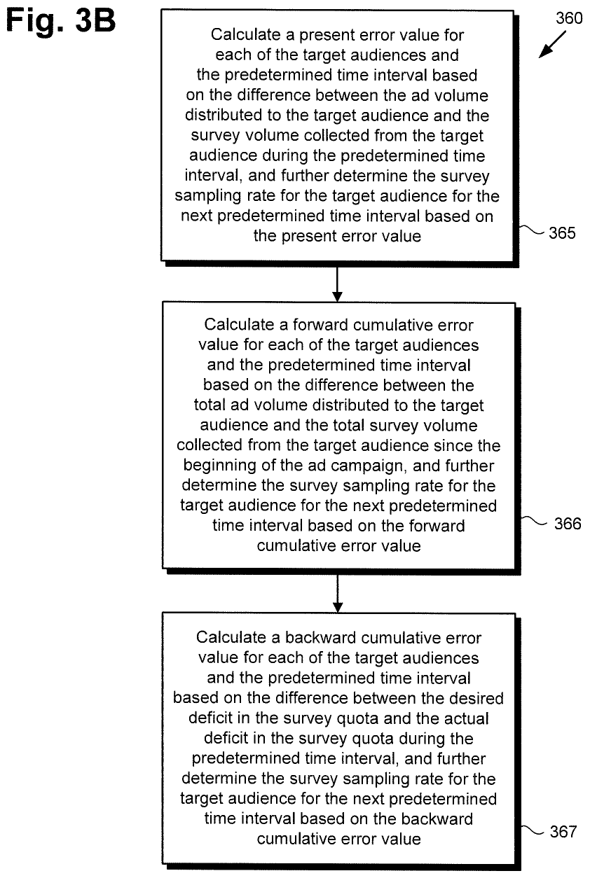

The functionality of software code 110/210 will be further described by reference to FIGS. 3A and 3B in combination with FIGS. 1 and 2. FIG. 3A shows flowchart 360 presenting an exemplary method for use by system 100 for synchronizing survey collection with ad distribution during an ad campaign, according to one implementation, while FIG. 3B shows exemplary additional actions extending the exemplary method outlined in FIG. 3A. With respect to the method outlined in FIGS. 3A and 3B, it is noted that certain details and features have been left out of flowchart 360 in order not to obscure the discussion of the inventive features in the present application.

Referring now to FIG. 3A in combination with FIGS. 1 and 2, flowchart 360 begins with receiving ad data 134/234 describing an ad volume distributed to each of target audiences 150 and 154 of an ad campaign during a predetermined time interval of the ad campaign (action 361). As noted above, target audiences 150 and 154 may represent tens, hundreds, or thousands of target audiences included in an ad campaign for which system 100 synchronizes survey collection with ad distribution. Action 361 corresponds to receiving ad data 134/234 describing the volume of ads 132, i.e., the number of ad units, distributed to exposed-group 151 of target audience 150, during a predetermined time interval of the ad campaign, as well as the volume of ads 132 distributed to exposed-group 155 of target audience 154 during the same predetermined time interval, and so forth for each target audience.

In some implementations, an ad campaign may span several days, weeks, or months. However, in other implementations an ad campaign may be relatively brief, lasting no longer than the telecasting of a live event, such as a sporting event for example. As a result, and depending on the desired frequency with which survey collection and ad distribution are to be synchronized, the predetermined time interval over which the volume of distributed ads 132 is counted may vary depending on the specific ad campaign use case. In some instances, it may be advantageous or desirable for the predetermined time interval to be a twenty-four hour time interval, resulting in the ad volume being a daily ad volume. However, in other use cases, the predetermined time interval may be shorter or substantially shorter than twenty-four hours, such as a few hours, one hour, or less than sixty minutes. In yet other use cases, it may be advantageous or desirable for the predetermined time interval to be longer than twenty-four hours.

Ad data 134/234 including the ad volume distributed to each of target audiences 150 and 154 during the predetermined time interval of the ad campaign may be generated by ad delivery system 130, and may be received in action 361 by software code 110/210 of system 100, executed by hardware processor 104. As shown in FIG. 2, ad data 134/234 may be received by survey distribution control module 218 in action 361. As further shown in FIG. 2, in implementations in which software code 110/210 includes one or more of optional present error module 212, forward cumulative error module 214, and backward cumulative error module 216, ad data 134/234 may also be received by each of the error modules present.

It is noted that the data flow shown in FIG. 2 is merely exemplary. That is to say, although FIG. 2 depicts present error module 212 as receiving ad data 134/234 directly, forward cumulative error module 214 receiving ad data 134/234 from present error module 212, and backward cumulative error module 216 receiving ad data 134/234 from forward cumulative error module 214, any other ordering of the reception and transfer of ad data 134/234 may be implemented. Moreover, in some implementations in which software code 110/210 includes one or more of optional present error module 212, forward cumulative error module 214, and backward cumulative error module 216, ad data 134/234 may be received by any one or more of those error modules concurrently.

Flowchart 360 continues with receiving survey data 146/246 describing a survey volume distributed to each of target audiences 150 and 154 and a survey response volume collected from each of target audiences 150 and 154 during the predetermined time interval (action 362). Action 362 corresponds to receiving survey data 146/246 describing the volume of surveys 142a (i.e., the number of surveys) distributed to exposed-group 151 and control-group 152 of target audience 150 during the same predetermined time interval of the ad campaign over which ad data 134/234 is collected, as well as the volume of surveys 142b distributed to exposed-group 155 and control-group 156 of target audience 154 during that predetermined time interval, and so forth for each target audience. Survey data 146/246 also describes the volume of survey responses 144a (i.e., the number of survey responses) collected from exposed-group 151 and control-group 152 of target audience 150 during the same predetermined time interval, as well as the volume of survey responses 144b collected from exposed-group 155 and control-group 156 of target audience 154 during the same predetermined time interval, and so forth for each target audience.

Survey data 146/246 including the survey volume distributed to each of target audiences 150 and 154 and the survey response volume collected from each of target audiences 150 and 154 during the predetermined time interval may be generated by survey distribution and collection system 140, and may be received in action 362 by software code 110/210 of system 100, executed by hardware processor 104. As shown in FIG. 2, survey data 146/246 may be received by survey distribution control module 218 in action 362. As further shown in FIG. 2, in implementations in which software code 110/210 includes one or more of optional present error module 212, forward cumulative error module 214, and backward cumulative error module 216, survey data 146/246 may also be received by each of the error modules present.

It is reiterated that the data flow shown in FIG. 2 is merely exemplary. Thus, although FIG. 2 depicts present error module 212 as receiving survey data 146/246 directly, forward cumulative error module 214 receiving survey data 146/246 from present error module 212, and backward cumulative error module 216 receiving survey data 146/246 from forward cumulative error module 214, any other ordering of the reception and transfer of survey data 146/246 may be implemented. Moreover, in some implementations in which software code 110/210 includes one or more of optional present error module 212, forward cumulative error module 214, and backward cumulative error module 216, survey data 146/246 may be received by any one or more of those error modules concurrently.

In some implementations, flowchart 360 continues with the optional action of estimating a next ad distribution volume for each of target audiences 150 and 154 for a next predetermined time interval of the ad campaign (action 363). As noted above, the volume of ads 132 distributed to target audience 150 and the volume of ads 132 distributed to target audience 154 may fluctuate over the course of the ad campaign. For example daily fluctuations in traffic on one or both of content distribution platforms 136a and 136b may result in such fluctuations. Consequently, in implementations in which the predetermined time interval referred to by actions 361 and 362 is a day, for example, the volume of ads distributed on one day may be different from the volume of ads distributed the next day, resulting in different next ad distribution volume 138/238. Next ad distribution volume 138/238 may be estimated based on data received from ad delivery system 130, for example, and that estimation may be performed in optional action 363 by software code 110/210 of system 100, executed by hardware processor 104.

According to some implementations, flowchart 360 can conclude with determining next survey sampling rate 128/228 for each of target audiences 150 and 154 for the next predetermined time interval of the ad campaign based at least on ad data 134/234 and survey data 146/246, such that the volume of survey responses 144a and 144b collected from each of target audiences 150 and 154 matches the ad distribution volume to each of target audiences 150 and 154 within a predetermined threshold during each predetermined time interval of the ad campaign (action 364). Action 364 may be performed using survey distribution control module 218 of software code 110/210, executed by hardware processor 104 of system 100. It is noted that in implementations in which flowchart 360 includes optional action 363, the determination of next survey sampling rate 128/228 for each of target audiences 150 and 154 for the next predetermined time interval of the ad campaign may be further based on the estimated next ad distribution volume.

In some implementations, the predetermined threshold within which the survey responses collected from each target population must match may be one or a few percentage points, such as one to five percent, for example. In some implementations, as noted above, survey distribution control module 218 may be implemented as a PID controller. In those implementations, survey distribution control module 218 acts as a closed-loop control module that determines the next survey sampling rate based on one or more negative feedback signals.

Referring to FIG. 3B with continued reference to FIGS. 1 and 2, in some implementations, the method outlined in flowchart 360 can be extended to include calculating present error value 222 for each of target audiences 150 and 154, and the predetermined time interval, based on the difference between the ad volume distributed to each target audience and the survey response volume collected from that target audience during the present predetermined time interval, and further determining next survey sampling rate 128/228 for each of the target audiences for the next predetermined time interval based on present error value 222 for the present predetermined time interval (action 365). Action 365 may be performed by software code 110/210, executed by hardware processor 104, and using present error module 212 and survey distribution control module 218.

For example, next survey sampling rate 128/228 may be further determined as the sum of the value determined in action 364 and present error value 222. In some implementations it may be advantageous or desirable to apply a weighting factor to present error value 222 in such a sum. For instance, where NSSR_{F} is the further determined value of next survey sampling rate 128/228, NSSR_{I} is the initial value of next survey sampling rate 128/228 determined in action 364, and PE is present error value 222, NSSR_{F} may be expressed as:

NSSR_{F}=NSSR_{I}αPE,

where α is a tunable weighting factor.

As an alternative to action 365, or in addition to it, flowchart 360 can be extended to include calculating forward cumulative error value 224 for each of target audiences 150 and 154, and the predetermined time interval, based on the difference between a total ad volume distributed to each target audience and a total survey response volume collected from that target audience since the beginning of the ad campaign, and further determining next survey sampling rate 128/228 for each of the target audiences for the next predetermined time interval based on forward cumulative error value 224 since the beginning of the ad campaign (action 366). Action 366 may be performed by software code 110/210, executed by hardware processor 104, and using forward cumulative error module 214 and survey distribution control module 218.

For example, next survey sampling rate 128/228 may be further determined as the sum of the value determined in action 364 and forward cumulative error value 224, or the sum of the value determined in action 365 and forward cumulative error value 224. In some implementations it may be advantageous or desirable to apply a weighting factor to forward cumulative error value 224 in such a sum. For instance, where NSSR_{F} is the further determined value of next survey sampling rate 128/228, NSSR_{I} is the initial value of next survey sampling rate 128/228 determined in action 464, and PE is present error value 222, as noted above, and where FCE is forward cumulative error value 224, NSSR_{F} may be expressed as:

NSSR_{F}=NSSR_{I}+βFCE,

where β is a tunable weighting factor, or as:

NSSR_{F}=NSSR_{I}+αPE+βFCE,

where each of α and β is a tunable weighting factor.

As an alternative to either or both of actions 365 and 366, or in addition to actions 365 and 366, flowchart 360 can be extended to include calculating backward cumulative error value 226 for each of target audiences 150 and 154, and the predetermined time interval, based on the difference between a desired deficit in the survey quota and the actual deficit in the survey quota during the present predetermined time interval, and further determining next survey sampling rate 128/228 for each of the target audiences for the next predetermined time interval based on backward cumulative error value 226 during the present predetermined time interval (action 367). Action 367 may be performed by software code 110/210, executed by hardware processor 104, and using backward cumulative error module 216 and survey distribution control module 218.

For example, next survey sampling rate 128/228 may be further determined as the sum of the value determined in action 364 with backward cumulative error value 226, or the sum of the value determined in action 365 with backward cumulative error value 226, or any value determined in action 366 with backward cumulative error value 226. In some implementations it may be advantageous or desirable to apply a weighting factor to backward cumulative error value 226 in such a sum. For instance, where NSSR_{F} is the further determined value of next survey sampling rate 128/228, NSSR_{I} is the initial value of next survey sampling rate 128/228 determined in action 364, PE is present error value 222, and FCE is forward cumulative error value 224, as noted above, and where BCE is backward cumulative error value 226, NSSR_{F} may be expressed as:

NSSR_{F}=NSSR_{I}+γBCE,

where γ is a tunable weighting factor, or as:

NSSR_{F}=NSSR_{I}+αPE+γBCE,

where each of α and γ is a tunable weighting factor, or as:

NSSR_{F}=NSSR_{I}+βFE+γBCE,

where each of β and γ is a tunable weighting factor, or as:

NSSR_{F}=NSSR_{I}+αPC+βFE+γBCE,

where each of α, β, and γ is a tunable weighting factor.

It is emphasized that flowchart 360 may conclude with action 364 in FIG. 3A, or may be extended to include one or more of actions 365, 366, and 367, in FIG. 3B.

Moreover, actions 365, 366, and 367 may be performed in any order, or may be performed substantially concurrently. It is also noted that, in some implementations, hardware processor 104 may execute software code 110/210 to perform actions 361, 362, and 364, or 361, 362, 363, and 364 (hereinafter “actions 361-364”), and/or actions 361, 362, and 364 or actions 361-364 in combination with any one or more of actions 365, 366, and 367, in an automated process from which human involvement is omitted.

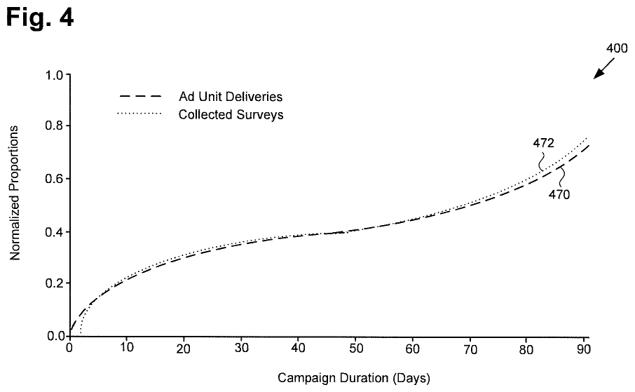

FIG. 4 shows exemplary simulation 400 comparing survey collection with ad distribution over the course of an ad campaign. According to simulation 400, curve 470 corresponds to the ad units delivered daily over the ninety day course of an exemplary ad campaign, while curve 472 corresponds to the number of surveys collected each day of the ad campaign. As discussed above by reference to FIG. 1, S(p, d, t) denotes the number of surveys collected on content distribution platform p for user demographic d during predetermined time interval t (e.g., each day), S_{Q} denotes the survey quota, A(p, d, t) denotes the number of ad units (i.e., the ad volume) distributed on content distribution platform p for user demographic d during predetermined time interval t (e.g., each day), and A_{T} denotes the total ad budget. The substantial match between curves 470 and 472 of simulation 400 indicate that the survey distribution control solution disclosed by the present application successfully adjusts the distributed survey volume SV(p,d,t) on content distribution platform p for user demographic d during predetermined time interval t, such that:

S_{Control}(p,d,t)=S_{Q-Control}=S_{Exposed}(p,d,t)/S_{Q-Exposed}≈A(p,d,t)/A_{T}

for every combination of p, d, and t during the ad campaign, as desired.

Thus, the present application discloses systems and methods for synchronizing survey collection with ad distribution during an ad campaign that overcome the drawbacks and deficiencies in the conventional art. In contrast to conventional solutions for distributing and collecting surveys during an ad campaign, the systems and methods disclosed herein advantageously enable real-time responsiveness over the course of an entire campaign. That is to say, by leveraging audience parameters that may include demographics, DMP data, and content data such as a show name or episode number of content being consumed by an audience member, and doing so in real-time, the present concepts ensure that the right ad and/or right survey is reliably served to the right audience member at the right time. Conventional solutions are unable to access and utilize comparable audience parameters in real-time. Those conventional solutions implement an essentially random sampling from the overall audience. Consequently, in the conventional art, there is often a significant mismatch between the audience group being surveyed, and an optimal survey group that is truly representative of the target audience.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a system memory storing a software code for controlling distribution of ad surveys to a plurality of target audiences during an ad campaign spanning a plurality of predetermined time intervals;
the hardware processor configured to execute the software code to:
receive ad data describing an ad volume distributed to each of the plurality of target audiences during a predetermined time interval of the ad campaign;
receive survey data describing a survey volume distributed to each of the plurality of target audiences and a survey response volume collected from each of the plurality of target audiences during the predetermined time interval; and
determine a next survey sampling rate for each of the plurality of target audiences for a next predetermined time interval of the ad campaign based on the ad data and the survey data, such that a volume of survey responses collected from each of the plurality of target audiences matches an ad distribution volume to each of the plurality of target audiences within a predetermined threshold during each of the plurality of predetermined time intervals of the ad campaign.

2. The system of claim 1, wherein the software code includes a proportional-integral-derivative (PID) controller, and wherein the hardware processor is configured to further execute the software code to determine the next survey sampling rate for each of the plurality of target audiences for the next predetermined time interval of the ad campaign using the PID controller.

3. The system of claim 1, wherein the hardware processor is configured to further execute the software code to calculate a present error value for each of the plurality of target audiences and the predetermined time interval based on a difference between the ad volume distributed to each of the plurality of target audiences and the survey response volume collected from each of the plurality of target audiences during the predetermined time interval, and wherein the next survey sampling rate for each of the plurality of target audiences for the next predetermined time interval is further determined based on the present error value for the predetermined time interval.

4. The system of claim 3, wherein the hardware processor is configured to further execute the software code to calculate a forward cumulative error value for each of the plurality of target audiences and the predetermined time interval based on a difference between a total ad volume distributed to each of the plurality of target audiences and a total survey response volume collected from each of the plurality of target audiences since a beginning of the ad campaign, and wherein the next survey sampling rate for each of the plurality of target audiences for the next predetermined time interval is further determined based on the forward cumulative error value.

5. The system of claim 3, wherein the hardware processor is configured to further execute the software code to calculate a backward cumulative error value for each of the plurality of target audiences and the predetermined time interval based on a difference between a desired deficit in a survey quota and an actual deficit in the survey quota during the predetermined time interval, and wherein the next survey sampling rate for each of the plurality of target audiences for the next predetermined time interval is further determined based on the backward cumulative error value.

6. The system of claim 4, wherein the hardware processor is configured to further execute the software code to calculate a backward cumulative error value for each of the plurality of target audiences and the predetermined time interval based on a difference between a desired deficit in a survey quota and an actual deficit in the survey quota during the predetermined time interval, and wherein the next survey sampling rate for each of the plurality of target audiences for the next predetermined time interval is further determined based on the backward cumulative error value.

7. The system of claim 1, wherein the hardware processor is configured to further execute the software code to calculate a forward cumulative error value for each of the plurality of target audiences and the predetermined time interval based on a difference between a total ad volume distributed to each of the plurality of target audiences and a total survey response volume collected from each of the plurality of target audiences since a beginning of the ad campaign, and wherein the next survey sampling rate for each of the plurality of target audiences for the next predetermined time interval is further determined based on the forward cumulative error value.

8. The system of claim 7, wherein the hardware processor is configured to further execute the software code to calculate a backward cumulative error value for each of the plurality of target audiences and the predetermined time interval based on a difference between a desired deficit in a survey quota and an actual deficit in the survey quota during the predetermined time interval, and wherein the next survey sampling rate for each of the plurality of target audiences for the next predetermined time interval is further determined based on the backward cumulative error value.

9. The system of claim 1, wherein the hardware processor is configured to further execute the software code to calculate a backward cumulative error value for each of the plurality of target audiences and the predetermined time interval based on a difference between a desired deficit in a survey quota and an actual deficit in the survey quota during the predetermined time interval, and wherein the next survey sampling rate for each of the plurality of target audiences for the next predetermined time interval is further determined based on the backward cumulative error value.

10. The system of claim 1, wherein the hardware processor is configured to further execute the software code to estimate a next ad distribution volume for each of the plurality of target audiences for the next predetermined time interval of the ad campaign, and wherein the next survey sampling rate for each of the plurality of target audiences for the next predetermined time interval is further determined based on the estimated next ad distribution volume.

11. A method for use by a system including a computing platform having a hardware processor and a system memory storing a software code for controlling distribution of ad surveys to a plurality of target audiences during an ad campaign spanning a plurality of predetermined time intervals, the method comprising:
receiving, by the software code executed by the hardware processor, an ad data describing an ad volume distributed to each of the plurality of target audiences during a predetermined time interval of the ad campaign;
receiving, by the software code executed by the hardware processor, a survey data describing a survey volume distributed to each of the plurality of target audiences and a survey response volume collected from each of the plurality of target audiences during the predetermined time interval; and
determining, by the software code executed by the hardware processor, a next survey sampling rate for each of the plurality of target audiences for the next predetermined time interval of the ad campaign based on the ad data and the survey data, such that a volume of survey responses collected from each of the plurality of target audiences matches an ad distribution volume to each of the plurality of target audiences within a predetermined threshold during each of the plurality of predetermined time intervals of the ad campaign.

12. The method of claim 11, wherein the software code includes a proportional-integral-derivative (PID) controller, and wherein determining the next survey sampling rate for each of the plurality of target audiences for the next predetermined time interval of the ad campaign is performed using the PID controller.

13. The method of claim 11, further comprising calculating, by the software code executed by the hardware processor, a present error value for each of the plurality of target audiences and the predetermined time interval based on a difference between the ad volume distributed to each of the plurality of target audiences and the survey response volume collected from each of the plurality of target audiences during the predetermined time interval, and wherein the next survey sampling rate for each of the plurality of target audiences for the next predetermined time interval is further determined based on the present error value for the predetermined time interval.

14. The method of claim 13, further comprising calculating, by the software code executed by the hardware processor, a forward cumulative error value for each of the plurality of target audiences and the predetermined time interval based on a difference between a total ad volume distributed to each of the plurality of target audiences and a total survey response volume collected from each of the plurality of target audiences since a beginning of the ad campaign, and wherein the next survey sampling rate for each of the plurality of target audiences for the next predetermined time interval is further determined based on the forward cumulative error value.

15. The method of claim 13, further comprising calculating, by the software code executed by the hardware processor, a backward cumulative error value for each of the plurality of target audiences and the predetermined time interval based on a difference between a desired deficit in a survey quota and an actual deficit in the survey quota during the predetermined time interval, and wherein the next survey sampling rate for each of the plurality of target audiences for the next predetermined time interval is further determined based on the backward cumulative error value.

16. The method of claim 14, further comprising calculating, by the software code executed by the hardware processor, a backward cumulative error value for each of the plurality of target audiences and the predetermined time interval based on a difference between a desired deficit in a survey quota and an actual deficit in the survey quota during the predetermined time interval, and wherein the next survey sampling rate for each of the plurality of target audiences for the next predetermined time interval is further determined based on the backward cumulative error value.

17. The method of claim 11, further comprising calculating, by the software code executed by the hardware processor, a forward cumulative error value for each of the plurality of target audiences and the predetermined time interval based on a difference between a total ad volume distributed to each of the plurality of target audiences and a total survey response volume collected from each of the plurality of target audiences since a beginning of the ad campaign, and wherein the next survey sampling rate for each of the plurality of target audiences for the next predetermined time interval is further determined based on the forward cumulative error value.

18. The method of claim 17, further comprising calculating, by the software code executed by the hardware processor, a backward cumulative error value for each of the plurality of target audiences and the predetermined time interval based on a difference between a desired deficit in a survey quota and an actual deficit in the survey quota during the predetermined time interval, and wherein the next survey sampling rate for each of the plurality of target audiences for the next predetermined time interval is further determined based on the backward cumulative error value.

19. The method of claim 11, further comprising calculating, by the software code executed by the hardware processor, a backward cumulative error value for each of the plurality of target audiences and the predetermined time interval based on a difference between a desired deficit in a survey quota and an actual deficit in the survey quota during the predetermined time interval, and wherein the next survey sampling rate for each of the plurality of target audiences for the next predetermined time interval is further determined based on the backward cumulative error value.

20. The method of claim 11, further comprising estimating, by the software code executed by the hardware processor, a next ad distribution volume for each of the plurality of target audiences for the next predetermined time interval of the ad campaign, and wherein the next survey sampling rate for each of the plurality of target audiences for the next predetermined time interval is further determined based on the estimated next ad distribution volume.
